(19) United States
(12) Patent Application Publication
(10) Pub. No.: US 2009/0242663 A1
(43) Pub. Date: Oct. 1, 2009

(54) MEDICAL LIQUID DROPLET APPARATUS

(75) Inventor: NENG-CHIH YU, Taipei County (TW)

Correspondence Address: WPAT, PC, 7225 BEVERLY ST., ANNANDALE, VA, 22003, US

(73) Assignee: QUATEK CO., LTD., Taipei City (TW)

(21) Appl. No.: 12/410,647

(22) Filed: Mar. 25, 2009

Related U.S. Application Data
(63) Continuation-in-part of application No. 12/128,970, filed on May 29, 2008.

(30) Foreign Application Priority Data
Mar. 25, 2008 (TW) 097110475

(51) Int. Cl. B05B 17/06

(52) U.S. Cl. 239/102.2

(57) ABSTRACT

The present invention provides a medical liquid droplet apparatus, which comprises a driving base and a polymeric film. The driving base is capable of providing a vibrating energy. The polymeric film, having a plurality of tiny openings formed thereon, is disposed on the driving base for receiving the vibrating energy so as to generating liquid droplet. By means of the present invention, the embrittled problem due to the high frequency vibration occurred in the conventional nebulizing film or malfunction due to the chemical eroding of the conventional vibrating film can be avoided.

### FIELD OF THE INVENTION

The present invention relates to an improved nebulizer, and more particularly, to a medical liquid droplet apparatus having a polymeric film configured therein to be used as its vibration source.

### BACKGROUND OF THE INVENTION

A patient, who suffers from asthma or a chronic bronchial disease, may have to take an inhalation therapy, for example, to take a bronchiectatic spray when getting a trouble in breathing. Various nebulizers have been disclosed for nebulizing liquid medicine, enabling nebulized medicine to be easily inhaled by the patient, whereas the nebulization speed can be an important index for measuring the performance of an individual nebulizer.

Conventional nebulizers can be divided into two categories: high-efficiency and reduced-efficiency. A high-efficiency nebulizer usually is a bulky device that can nebulize a solution with a comparably better nebulization speed, but at the cost of more electricity consumed. On the other hand, a reduced-efficiency nebulizer usually is a small device that can nebulize a solution using less electricity, but at an inferior nebulization speed instead. Although the aforesaid two types of nebulizers have their respective pros and cons, generally they all adopt a nebulization element that is made of metal, as the liquid atomizing apparatus disclosed in U.S. Pat. No. 6,863,224 that is shown in FIG. 1. In FIG. 1, the vibration of an ultrasonic vibration source 10 is transmitted to a nebulization element 11 for causing the same to vibrate correspondingly. In addition, as the nebulization element 11 is configured with a plurality of openings, the nebulization element 11 is capable of nebulizing liquid into mist as it is vibrating. It is noted that the nebulization element 11 used in the aforesaid liquid atomizing apparatus is manufactured by an electroforming means using a NiPD alloy.

In another liquid nebulizing device disclosed in U.S. Pat. No. 7,066,398, its nebulization element, being referred as the plate body in the aforesaid patent, is also made of metal, such as palladium, palladium nickel alloy or other palladium alloys. In addition, in the droplet ejector with oscillating tapered aperture disclosed in U.S. Pat. No. 6,629,646, its nebulization element is also an electroforming metal sheet. Thus, it is concluded that most prior-art nebulization elements are made of metal or metallic alloy. However, those metallic nebulization elements have the following shortcomings:
(1) As the nebulization element is designed to be driven to vibration by the high-frequency vibration of a vibration source, any nebulization element that is made of metal can be embrittled when it is vibrating in high frequency for a conceivable long period of time and any nebulization element that is embrittled will have severe adverse affect upon the nebulization efficiency.
(2) It is known that nebulizer has many applications, but in some particular application such as medical nebulizer, its lifespan as well as its nebulization efficiency might be adversely affected since its metallic nebulization element might be subjected to the erosion of certain chemical substances containing in the medicine that the nebulizer is going to atomized.

Therefore, it is in great need to have a medical liquid droplet apparatus that is not troubled by the aforesaid problems.

### SUMMARY OF THE INVENTION

The object of the present invention is to provide a medical liquid droplet apparatus having a polymeric film configured therein to be used as its nebulizing film, which can prevent the medical liquid droplet apparatus from malfunctioning due to the medicine eroding so as to maintain the polymeric film to function normally for a specific period of time.

Another object of the present invention is to provide a medical liquid droplet apparatus having a polymeric film configured therein to be used as its nebulizing film, which can prevent the embrittled problem due to the high frequency vibration occurred in the conventional metallic nebulizing film from happening so as to maintain the polymeric film to function normally for a specific period of time.

A further object of the present invention is to provide a medical liquid droplet apparatus comprising a polymeric film which has a plurality of tiny openings formed thereon, wherein diameter of each tiny opening is between 2˜6 μm, and center-to-center distance between the adjacent two tiny openings is between 60˜180 μm. By means of the arrangement of the foregoing opening characteristics, it is capable of generating a better size of the droplet and sufficient spray quantity so as to be suitable for being utilized in the medical field.

In an exemplary embodiment of the invention, a medical liquid droplet apparatus is provided, which comprises: a driving base, for providing a vibrating energy; and a polymeric film, having a plurality of tiny openings formed thereon and being disposed on the driving base for receiving the vibrating energy so as to generating liquid droplets.

Preferably, the driving base further comprises: an energy conductor, connected to the polymeric film and having an hole formed thereon in a manner that the hole is located at a position corresponding to the plural tiny openings of the polymeric film; and a vibrating source, connected to the energy conductor and being capable of generating vibration for providing the vibrating energy.

Preferably, the driving base further comprises: an energy conductor, connected to the polymeric film and having an hole formed thereon in a manner that the hole is located at a position corresponding to the plural tiny openings of the polymeric film; and a vibrating source, connected to the energy conductor and being capable of generating vibration for providing the vibrating energy; wherein the energy conductor is further configured with a cone structure for raising the level of the energy conductor connecting to the polymeric film above the level of the same connecting to the vibrating source by a specific height.

Preferably, the driving base further comprises: a ring-like vibrating source, capable of generating vibration for providing the vibrating energy; and an energy conductor, being a ring-like structure configured with an hole for mounting on the inner wall of the ring-like vibrating source so as to be connected to the polymeric film in a manner that the hole of the ring-like energy conductor is located at a position corresponding to the plural tiny openings of the polymeric film.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a cut-away perspective view of a liquid atomizing apparatus disclosed in U.S. Pat. No. 6,863,224.

FIG. 2A is a top view of a medical liquid droplet apparatus according to a first embodiment of the invention.

FIG. 2B is a cross sectional view of the medical liquid droplet apparatus according to the first embodiment of the invention.

FIG. 2C is schematic diagram showing the operation of the medical liquid droplet apparatus of the first embodiment of the invention.

FIG. 3A is a top view of a medical liquid droplet apparatus according to a second embodiment of the invention.

FIG. 3B is a cross sectional view of the medical liquid droplet apparatus according to the second embodiment of the invention.

FIG. 4A is a cross sectional view of the medical liquid droplet apparatus according to the third embodiment of the invention.

FIG. 4B is a cross sectional view of the medical liquid droplet apparatus according to the fourth embodiment of the invention.

FIG. 5 is a cross sectional view of the medical liquid droplet apparatus according to the fifth embodiment of the invention.

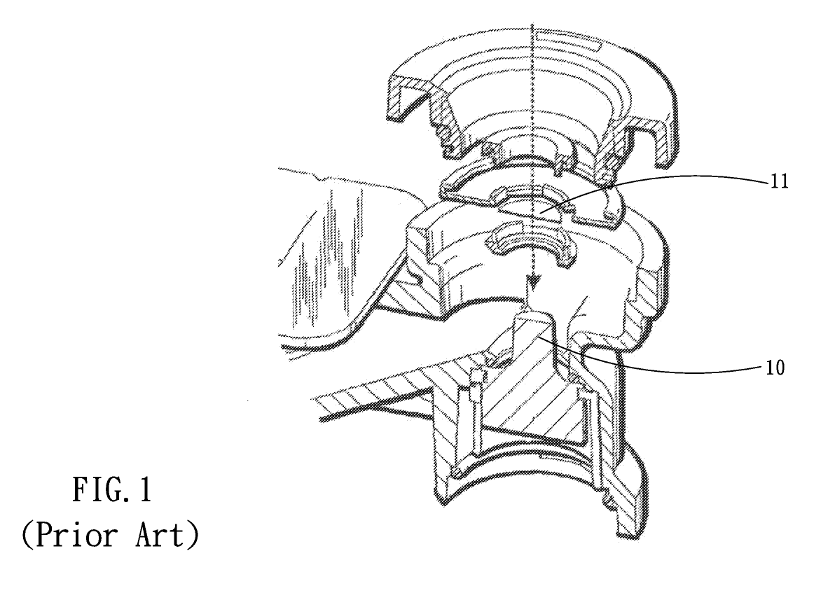

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

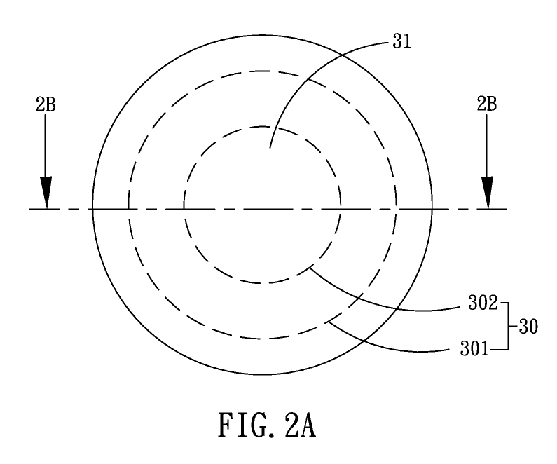

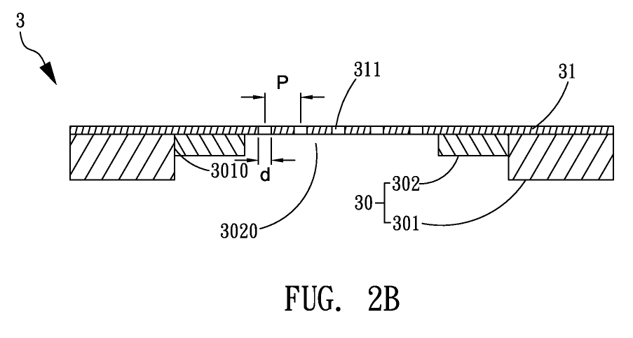

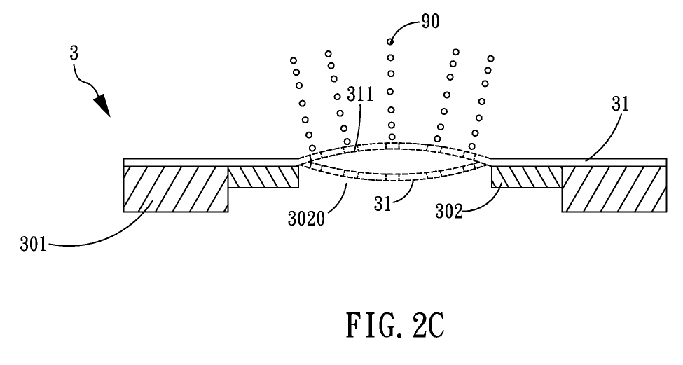

Please refer to FIG. 2A and FIG. 2B, which are a top view and a cross sectional view of a medical liquid droplet apparatus according to a first embodiment of the invention. In this second embodiment, the medical liquid droplet apparatus 3 comprises a driving base 30 and a polymeric film 31. The driving base 30, used for providing a vibrating energy, is further comprised of: a ring-like vibrating source 301 and an energy conductor 302, in which the ring-like vibrating source 301 which is capable of generating vibration for providing the vibrating energy, can be a device selected from the group consisting of an ultrasonic vibration unit and a piezoelectric vibration unit; and the energy conductor 302 which is a metallic ring-like structure configured with an hole 3020 for mounting on the inner wall 3010 of the ring-like vibrating source 301 so as to be connected to the polymeric film 31. In this first embodiment the metallic ring-like energy conductor 302 is made of stainless steel, but is not limited thereby. The polymeric film 31, being configured with a plurality tiny openings 311, is disposed on the driving base in a manner that it is connected to the ring-like vibrating source 301 and the energy conductor 302 in respective while enabling the hole 3020 of the ring-like energy conductor 302 to be located at a position corresponding to the plural tiny openings 311 of the polymeric film 31. In this first embodiment, the polymeric film 31 is made of a plastic, but is not limited thereby. The polymeric film 31 can be made of Teflon, polyethylene (PE) or other materials known to those skilled in the art. In FIG. 2B, the diameter d of each tiny opening 311 is between 2˜6 μm while the center-to-center distance P between the adjacent two tiny openings 311 is between 60˜180 μm. According to the arrangement with respect to the foregoing opening diameter d and pitch distance P, the polymeric film is capable of producing appropriate particle size of droplet and sufficient spray quantity suitable for providing desired medication effects for the application in medical field such as inhalation therapy for lung, respiratory or pulmonary disease.

Please refer to FIG. 2C, which is schematic diagram showing the operation of the medical liquid droplet apparatus of the first embodiment of the invention. In FIG. 2C, when the ring-like vibrating source 301 is being driven to vibrate, energy of the vibration will be transmitted to the polymeric film 31 through the energy conductor 302 which will cause the membrane area of the polymeric film corresponding to the hole 3020 of the energy conductor 302 to vibrate accordingly. Since metal has good energy conductivity, the metallic energy conductor 302 mounted on the inner wall of the ring-like vibrating source 301 can enhance the vibration of the polymeric film 31 and thus improve the nebulization efficiency of the medical liquid droplet apparatus.

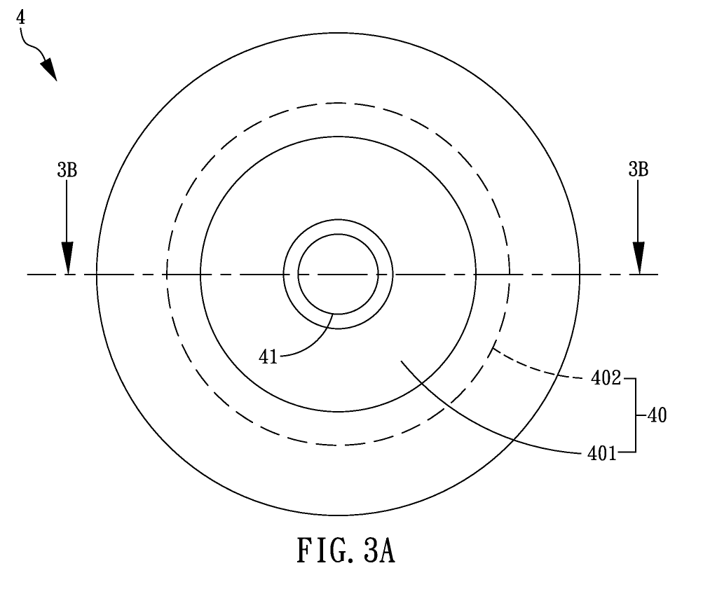

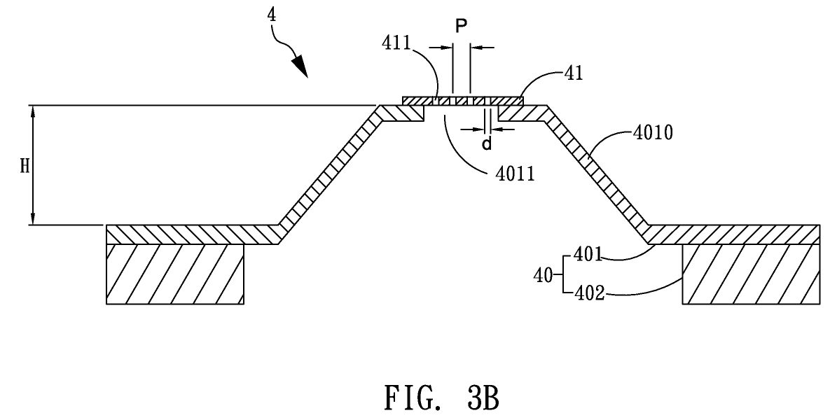

Please refer to FIG. 3A and FIG. 3B, which are a top view and a cross sectional view of a medical liquid droplet apparatus according to a second embodiment of the invention. In this first embodiment, the medical liquid droplet apparatus 4 comprises a driving base 40 and a polymeric film 41. The driving base 40, used for providing a vibrating energy, is further comprised of: a vibrating source 402 and an energy conductor 401, in which the energy conductor 401 is connected with the polymeric film 41 and is configured with an hole 4011 for receiving a liquid to be nebulized. In this second embodiment, the metallic energy conductor 401 is made of stainless steel, but is not limited thereby. Moreover, the vibrating source 402, being connected to the energy conductor 401, is capable of generating vibration for providing the vibrating energy. In this second embodiment, the vibrating source 402 can be a device selected from the group consisting of an ultrasonic vibration unit and a piezoelectric vibration unit; and is circularly disposed at the bottom of the energy conductor 401. It is noted that the means for driving the vibrating source 402 to vibrate is known to those skilled in the art and thus is not described further herein.

In FIG. 3B, the energy conductor 401 is further configured with a cone structure 4010 for raising the level of the energy conductor 401 connecting to the polymeric film 41 above the level of the same connecting to the vibrating source 402 by a specific height H. The polymeric film 41, which is configured with a plurality of tiny openings 411, is mounted on the driving base 40 for locating the plural tiny openings 411 at positions corresponding to the hole 4011 of the energy conductor 401. The polymeric film 41 is used for receiving the vibrating energy so as to generating liquid droplets. In this embodiment, the polymeric film 41 is made of a plastic, but is not limited thereby. As for the principle for causing the polymeric film 41 to vibrate, it is the same that described in the first embodiment and thus is not described further herein. In FIG. 3B, the diameter d of each tiny opening 411 is between 2˜6 μm while the center-to-center distance P between the adjacent two tiny openings 411 is between 60˜180 μm. According to the arrangement with respect to the foregoing opening diameter d and pitch distance P, the polymeric film is capable of producing appropriate particle size of droplet and sufficient spray quantity suitable for providing desired medication effects for the application in medical field such as inhalation therapy for lung, respiratory or pulmonary disease.

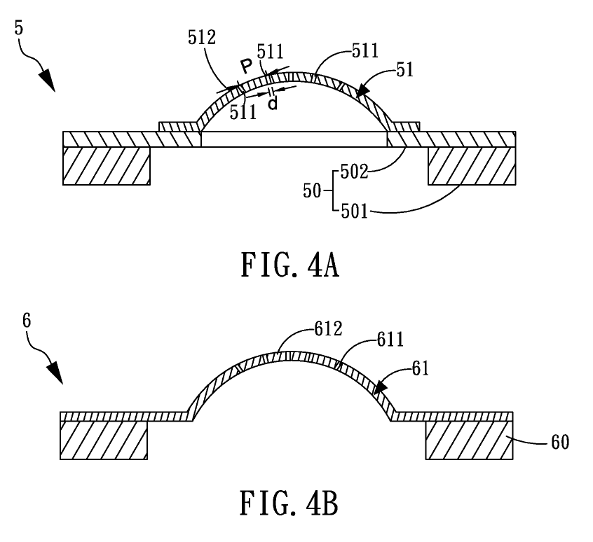

Please refer to FIG. 4A, which is a cross sectional view of a medical liquid droplet apparatus according to a third embodiment of the invention. In this third embodiment, the medical liquid droplet apparatus 5 comprises a driving base 50 and a polymeric film 51. The driving base 50, used for providing a vibrating energy, is further comprised of: a vibrating source 501 and an energy conductor 502, whose features are the same as those described in the prior embodiments and thus are not described further herein. The polymeric film 51 is configured with a plurality of openings 511 at positions corresponding to a hollowed area of the vibrating source 502. In FIG. 4A, the diameter d of each tiny opening 511 is between 2≠6 μm while the center-to-center distance P between the adjacent two tiny openings 511 is between 60˜180 μm. According to the arrangement with respect to the foregoing opening diameter d and pitch distance P, the polymeric film is capable of producing appropriate particle size of droplet and sufficient spray quantity suitable for providing desired medication effects for the application in medical field such as inhalation therapy for lung, respiratory or pulmonary disease. The characteristic of the medical liquid droplet apparatus shown in this third embodiment is that: the polymeric film 51 is configured with a curved area 512 with a specific curvature. Please refer to FIG. 4B, is a cross sectional view of a medical liquid droplet apparatus according to a fifth embodiment of the invention. In this fifth embodiment, the polymeric film 61 of the medical liquid droplet apparatus 6 is disposed directly on the vibrating source 60 while enabling the curved area 612 of the polymeric film 60 to be located at a position corresponding to the hollowed area of the vibrating source 60. Moreover, there is a plurality of tiny openings 611 formed on the curved area 612. It is noted that the vibrating source 60 can be an ultrasonic vibration unit or a piezoelectric vibration unit.

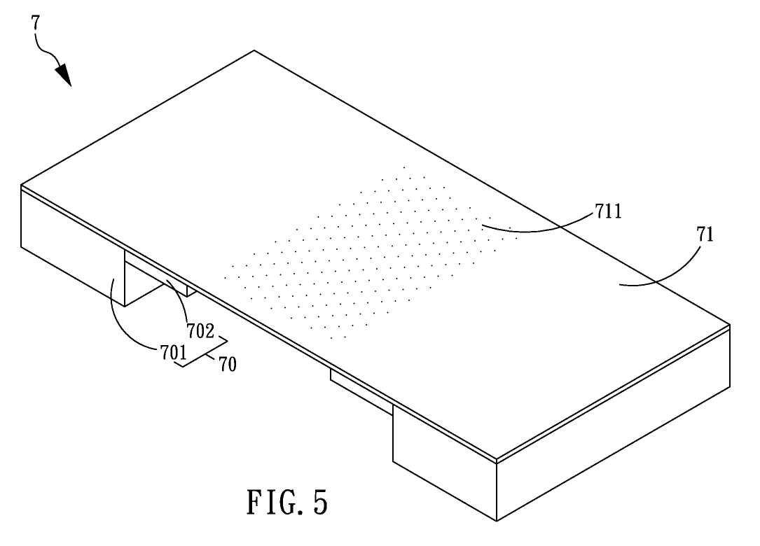

In addition, all the aforesaid energy conductors or vibrating sources are structured as ring-like structures, however, they can be formed in structures of other shapes. As shown in FIG. 5, the driving base of the medical liquid droplet apparatus 7 is not a ring-like structure. In FIG. 5, the driving base 70 comprises a vibrating source 701 and an energy conductor 702, and the vibrating source 701 is disposed at the two sides of the polymeric film 71 while mounting the energy conductor 702 on the inner walls of the vibrating source 701. It is noted that the polymeric film 71 is configured with a plurality of tiny openings 711 and is coupled to the vibrating source 701 and the energy conductor 702 at the same time. Meanwhile, in the FIG. 5, the diameter of each tiny opening is between 2˜6 μm while the center-to-center distance between the adjacent two tiny openings is between 60˜180 μm. According to the arrangement with respect to the foregoing opening diameter and pitch distance, the polymeric film is capable of producing appropriate particle size of droplet and sufficient spray quantity suitable for providing desired medication effects for the application in medical field such as inhalation therapy for lung, respiratory or pulmonary disease.

To sum up, the present invention provides a medical liquid droplet apparatus having a polymeric film configured therein to be used as its nebulizing film, which not only can prevent the medical liquid droplet apparatus from malfunctioning due to the medicine eroding, but also can prevent the embrittled problem due to the high frequency vibration occurred in the conventional metallic nebulizing film from happening, so that it can ensure its polymeric film to function normally for a specific period of time.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A medical liquid droplet apparatus, comprising:
a driving base, for providing a vibrating energy; and
a polymeric film, having a plurality of tiny openings formed thereon and being disposed on the driving base for receiving the vibrating energy so as to generating liquid droplets.

2. The medical liquid droplet apparatus of claim 1, wherein the diving base further comprises:
an energy conductor, connected to the polymeric film and having an hole formed thereon in a manner that the hole is located at a position corresponding to the plural tiny openings of the polymeric film; and
a vibrating source, connected to the energy conductor and being capable of generating vibration for providing the vibrating energy.

3. The medical liquid droplet apparatus of claim 2, wherein the energy conductor is made of a metal.

4. The medical liquid droplet apparatus of claim 2, wherein the vibrating source is a device selected from the group consisting of an ultrasonic vibration unit and a piezoelectric vibration unit.

5. The medical liquid droplet apparatus of claim 2, wherein the vibrating source is a ring-like structure.

6. The medical liquid droplet apparatus of claim 2, wherein the energy conductor is a ring-like structure.

7. The medical liquid droplet apparatus of claim 2, wherein the energy conductor is further configured with a cone structure for raising the level of the energy conductor connecting to the polymeric film above the level of the same connecting to the vibrating source by a specific height.

8. The medical liquid droplet apparatus of claim 2, wherein the polymeric film is configured with a curved structure at a position corresponding to the hole of the energy conductor while enabling the plural tiny openings to be formed on the curved structure.

9. The medical liquid droplet apparatus of claim 2, wherein the vibrating source is disposed at the two sides of the polymeric film while mounting the energy conductor on the inner walls of the vibrating source in a manner that the energy conductor is coupled with the polymeric film.

10. The medical liquid droplet apparatus of claim 1, wherein the driving base further comprises:
a ring-like vibrating source, capable of generating vibration for providing the vibrating energy; and
an energy conductor, being a ring-like structure configured with an hole for mounting on the inner wall of the ring-like vibrating source so as to be connected to the polymeric film in a manner that the hole of the ring-like energy conductor is located at a position corresponding to the plural tiny openings of the polymeric film.

11. The medical liquid droplet apparatus of claim 10, wherein the energy conductor is made of a metal.

12. The medical liquid droplet apparatus of claim 10, wherein the vibrating source is a device selected from the group consisting of an ultrasonic vibration unit and a piezoelectric vibration unit.

13. The medical liquid droplet apparatus of claim 1, wherein the driving base is substantially a ring-like vibrating source configured with a hollowed area that is capable of generating vibration for providing the vibrating energy.

14. The medical liquid droplet apparatus of claim 13, wherein the polymeric film is configured with a curved structure at a position corresponding to the hollowed area of the driving base while enabling the plural tiny openings to be formed on the curved structure.

15. The medical liquid droplet apparatus of claim 1, wherein polymeric film is made of a material selected from the group consisting of: plastic, Teflon and polyethylene (PE).

16. The medical liquid droplet apparatus of claim 1, wherein diameter of each tiny opening is between 2˜6 μm.

17. The medical liquid droplet apparatus of claim 1, wherein center-to-center distance between the adjacent two tiny openings is between 60˜180 μm.
